(19) United States
(12) Patent Application Publication
(10) Pub. No.: US 2023/0133007 A1
(43) Pub. Date: May 4, 2023

(54) Method of Generation and Securing a Financial Maturity Scoring

(71) Applicant: Gaganjit Sandhu, San Francisco, CA (US)

(72) Inventor: Gaganjit Sandhu, San Francisco, CA (US)

(21) Appl. No.: 18/050,340

(22) Filed: Oct. 27, 2022

Related U.S. Application Data
(60) Provisional application No. 63/272,956, filed on Oct. 28, 2021.

(51) Int. Cl. G06Q 40/06; G06Q 30/02; G06Q 20/36

(52) U.S. Cl. CPC G06Q 40/06; G06Q 30/0203; G06Q 20/363; G06Q 2220/00

(57) ABSTRACT

A Money score is generated and secured on a server, where the Money score results from a plurality of prompts entered by a user and financial account data, where the Money score is accessible via an electronic wallet and is a representation of a user financial knowledge rather than a person's credit worthiness.

### RELATED ART

This application claims the benefit of the priority of U.S. Provisional Application No. 63/272,956, filed on Oct. 28, 2021, titled “Method of Generation and Securing a Financial Maturity Scoring,” and is incorporated by reference in its entirety herein.

### BACKGROUND OF THE INVENTION

### Field of the Invention

This invention generally relates to wealth management and, more particularly, to financial wellness.

### Background

A requirement for opening a brokerage stock or commodity account is the verification of suitability and knowledge of investing. This verification typically is accomplished by simply asking the person if they have experience. A person answering such a question may be uncomfortable telling the truth or fail to fully understand the question. No understanding of financial knowledge, wisdom, and foresight occurs, and no quantitative measurement occurs.

Often a credit score is erroneously used as an indication of financial knowledge. The problem with such an approach is that a credit score is a measure of creditworthiness and not financial knowledge. Just because a person pays their bills on time does not mean they have an understanding for making financial decisions.

Therefore, there is a need in the art for an approach to create a score for financial knowledge, wisdom, and foresight.

### SUMMARY

Systems and methods consistent with the present invention provide an approach for generating and updating a Money score. The Money score is a measure of financial knowledge, wisdom, and foresight for a person. A Money score is a summarized measure of all your financial decisions, and it is a representation of financial wellness, just as a credit score is a measure of creditworthiness. A Money score is generated by weighting predetermined questions and accessing a person's different types of accounts electronically. Additionally, the Money score is then secured in the cloud and can be accessed by a user with a code or anyone else that the code is provided.

The Money score will also help a person identify the areas where they might need some improvement. The great thing about a Money score is that a person has control over it and can take steps to improve it at their pace. Unlike credit scores, a low Money score is not a sentencing, rather the Money score is a true reflection of one's financial knowledge and experience. The Money score can improve with education and experience, which would help improve one's financial life in the long run.

Other methods, features, and advantages of the invention will become apparent to one with skill in the art upon examination of the following figures and detailed description. It is intended that all such additional methods, features, and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram 100 of a server 102 executing instructions for an approach to generate and store a Money score in accordance with an example implementation of the invention.

FIG. 2 is a block diagram 200 of a computer (desktop/laptop) 202 executing instructions for communicating with the server 102 of FIG. 1 in accordance with an example implementation of the invention.

FIG. 3 is a block diagram 300 of a mobile computing device (MCD) 302 executing instructions for communication with the server 102 of FIG. 1 to generate a Money score in accordance with an example implementation of the invention.

FIG. 4 is an illustration 400 of the mobile computing device (MCD) being used to access a Money score of FIG. 3 in accordance with an example implementation of the invention.

FIG. 5 is an illustration 500 of information used to generate a Money score 502 in accordance with an example implementation.

FIG. 6 is a table 600 of the correlation of the Money score factors in accordance with an example implementation of the invention.

FIG. 7 is a spider plot 700 of the Money score factors that result in a Money score in accordance with an example implementation of the invention.

FIG. 8 is a flow diagram 800 of the Money score approach running on a MCD of FIG. 4 in accordance with an example implementation of the invention.

### DETAILED DESCRIPTION

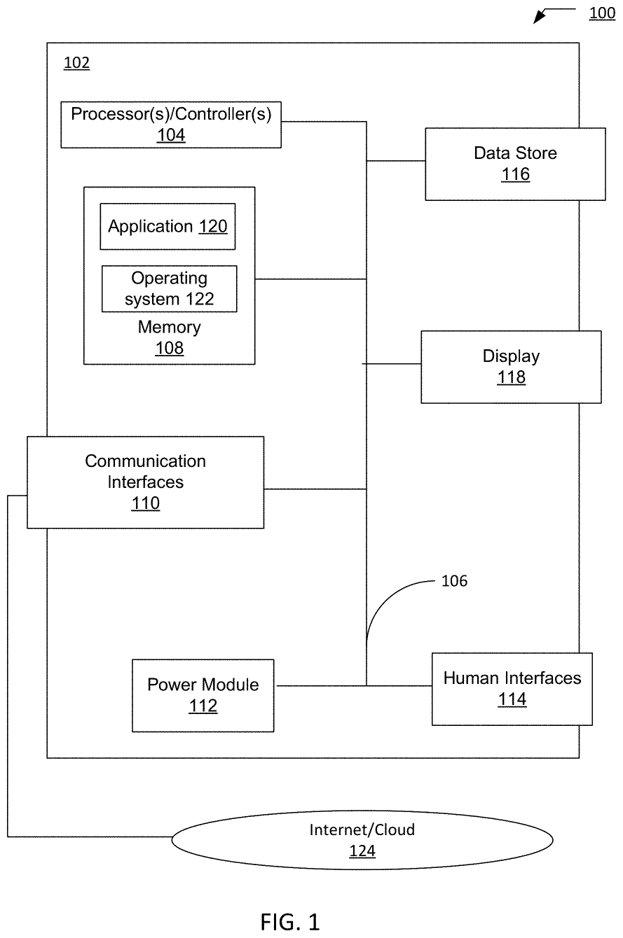

In FIG. 1, a block diagram 100 of server 102 executing instructions for determining and securing a Money score (also may be called Debit score or Mt. Diablo Score) approach is depicted in accordance with an example implementation of the invention. The server 102 has at least one processor or controller 104 coupled to a memory 108, communication interfaces 110 (i.e., wireless and/or wired), power module 112, human interface 114 (i.e., mouse, keyboard, microphone, camera), data store 116 (cloud storage, external database, internal disk), display 118 (i.e., graphics/video card, monitor) by a bus 106 (data, address, and/or power). The memory may be subdivided into an application memory 120 and operating system memory 122 that store instructions for determining and securing a Money score and the operating system. The memory 108 may be RAM/ROM/EEPROM/PROM to give but a few examples. The communication interfaces 110 connect the server 102 with one or more other networks, such as the internet/cloud 124. In other implementations, other networks may be accessed prior to or in addition to the internet cloud 124.

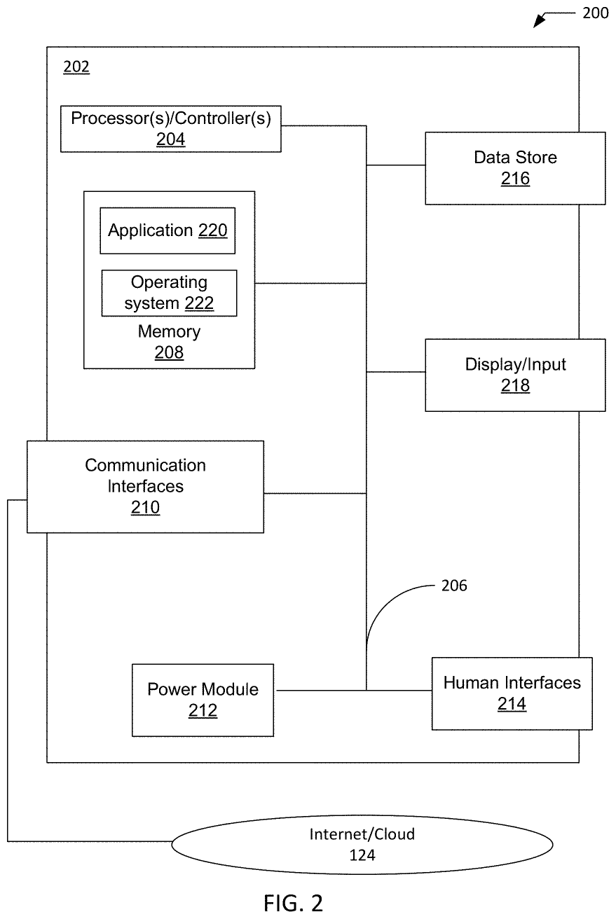

Turning to FIG. 2, a block diagram 200 of the computer (desktop/laptop) 202 executing instructions for communicating with the server 102 of FIG. 1 is depicted in accordance with an example implementation of the invention. The computer 202 has at least one processor or controller 204 coupled to a memory 208, communication interfaces 210 (i.e., wireless and/or wired), power module 212, human interface 214 (i.e., mouse, keyboard, microphone, camera), data store 216 (cloud storage, external database, internal disk), display 218 (i.e., graphics/video card, monitor) by a bus 206 (data, address, and/or power). The memory may be subdivided into application memory 220 and operating system memory 222. The memory 208 may be RAM/ROM/EEPROM/PROM to give but a few examples. The communication interfaces 210 connect the computer 202 with one or more other networks, such as the internet/cloud 124. In other implementations, other networks may be accessed prior to or in addition to the internet cloud 124.

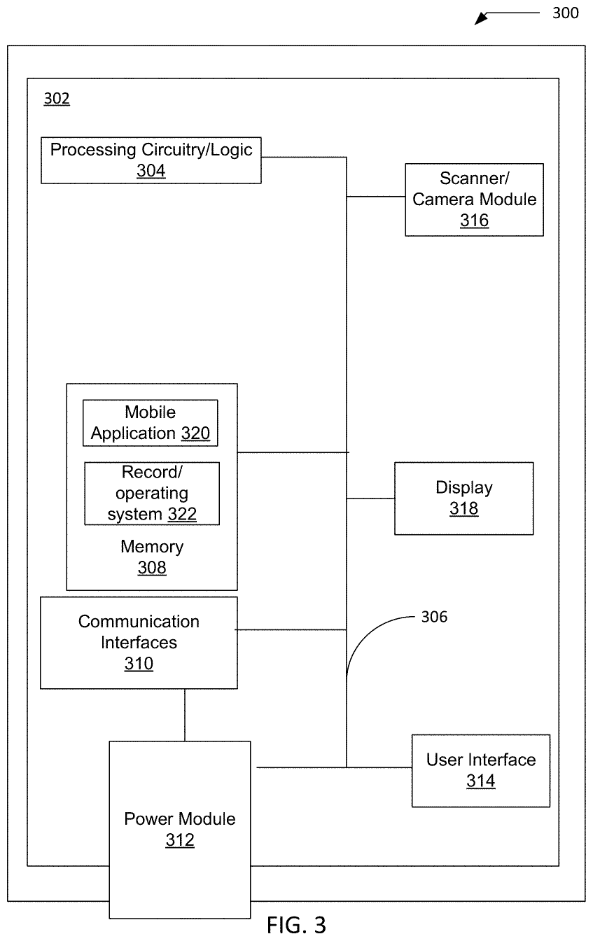

In FIG. 3, a block diagram 300 of a mobile computing device (MCD) 302 executing instructions for communication with the server 102 of FIG. 1 in accordance with an example implementation. The MCD 302 has at least one processor or controller 304 coupled to a memory 308, communication interfaces 310 (i.e., cellular, wireless internet, Bluetooth, GPS), power module 312 that may also be coupled with the communication interfaces via USB type (A, B, C, etc. . . .) connector, user interface 314 (i.e., touch screen, microphone), scanner/camera module 316, display 318 (i.e., graphics/video card, monitor) by a bus 306 (data, address, and/or power). The memory may be subdivided into a mobile application memory 320 and operating system/records memory 322. The memory 108 may be RAM/ROM/EEPROM/PROM to give but a few examples. The communication interfaces 110 connect the server 102 with one or more other networks, such as the internet/cloud 124, and also may connect to a cellular network. In other implementations, other networks may be accessed prior to or in addition to the internet cloud 124.

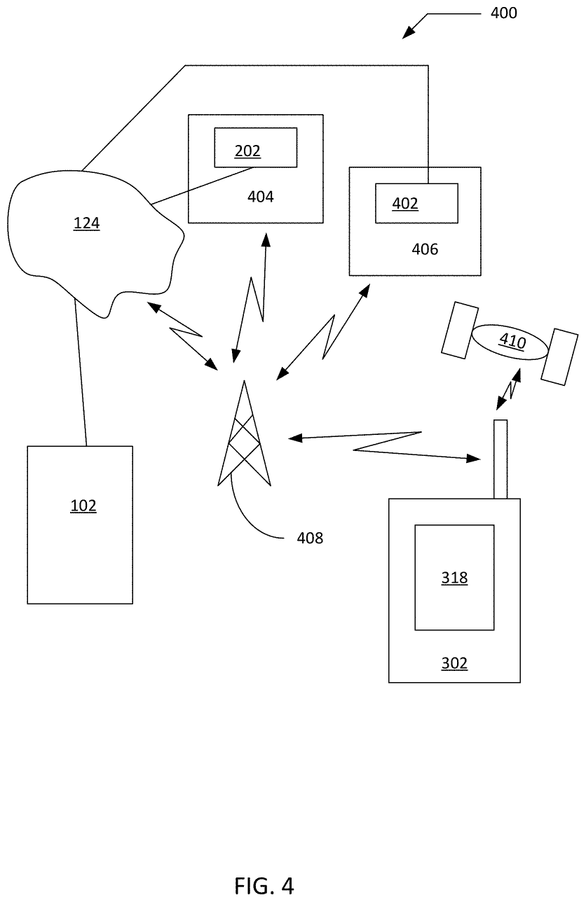

Turning to FIG. 4, an illustration 400 of a location-based mobile shopping computer network connecting local businesses 404, 406 selling items with local shoppers via their MCD 302 of FIG. 3. The MCD 302 receives location information from a plurality of GPS satellites (represented by satellite 401) and/or cellular network 408. The MCD 302 may also communicate with a data network, such as the internet 124 via wireless internet or the cellular network 408.

A server 102 hosting and/or accessing data to determine and secure Money score is connected to the internet 124. Similarly, other people or businesses 404 and 406 with computers 202 and 402 respectively are also connected to the internet. Depending upon the implementation, the computer 202 and 402 may be connected to the cellular network 408.

A user, using a network-connected device, such as MCD 302, access server 102, preferably using with world wide web (the web), and displays a webpage on the display 318 of the MCD 302 in response to the accessing the server 102. The connection or communication with server 102 may occur over a wireless nest 408 that connects to one or more other networks, commonly called the internet 124, that server 102 is also connected with.

Upon initially accessing the webpage for determining and securing a Money score, a user of the MCD 302 will be prompted to set up an account (Money score user account) with a user identification (ID) and password. that will be stored in a manner enabling access by the server (i.e., database located locally, remotely, or in the cloud accessible via the internet.) The initial generation of a Money score occurs with a plurality of weighted questions being presented to the user. Each answer carries a predetermined weight in the current implementation. The weighted answers are then processed, and a resulting Money score is provided to the user via display 318. The Money score is then saved in a manner similar to the user account. In addition, the Money score may be encrypted with a public/private key.

The weighted questions are associated with a plurality of Money score factors. The factors are Opportunity Cost, Motivation, Temperament, Digitization, Information (knowledge), Alpha, Beta, Leverage. All Money score factors work in relation to each other in determining a Money score. For instance, Age and Risk have a high correlation, whereas Risk and Alpha have some correlation as well. Temperament and Alpha have some correlation as well. All of these factors are used as input to derive a Money score. And since many of these factors can and will change over time, and their interplay will also change over time, a person's score will also change over time and can be in an updated Money score. Preferably, a Money score would be updated every three to six months.

Motivation (M)—A person's motivation and end goals play a significant role in determining the Money score. Because if you are motivated by your end goals, you are more likely to put in the effort to achieve those goals and be more disciplined and diligent. Motivation can make a 3% to 5% difference in the Money score.

Temperament (Time Period for Holding Investments) (T)—How long investments are held plays a considerable role in how much wealth you accumulate and also how high a Money score a person can have. This factor can make a 5% to 10% difference in a person's Money score.

Digitization (D)—A well-organized digital repository of all the information about a person's financial life makes retrieval and application of the information much more effortless. For instance, if a person has their home mortgage information all digitized in a spreadsheet, you can enter new refinance rates into the spreadsheet and find out within seconds whether it is worth the time and hassle to refinance at the new lower rate. We have calculated that this can make up to 5% difference in a Money score, and when combined with other factors, it can have as high as 10% impact.

Information (I)—How much knowledge a person possesses about the market, real estate, the economy, international commerce, and everything else related to the business world makes a difference in the quality of that person's financial decisions. This knowledge and information, combined with other factors, can make between 5-10% difference in their Money score.

Alpha (A)—The rate of return on investment has the most significant impact on the long-term financial outcome. And it also has the largest effect on a person's Money score. Alpha is described as the return on investment above a benchmark rate (i.e., S&P 500 index). Alpha can make 15% to 30% difference in a person's Money score in correlation with other attributes.

Beta (B)—Beta is a person's risk tolerance. Managing risk while pursuing investments has a pretty significant impact on long-term financial health and performance as well as the Money score. Too much or too little risk-taking, adjusted for age and other factors, will result in a lower Money score. On the other hand, managing risk well can make 5% to 15% difference in a person's Money score.

Leverage (L)—Leverage is your ability to manage debt wisely. When done well and strategically, debt management will enhance financial health & performance and also result in a higher score. No debt at all or too much debt will result in a lower score. A sound strategy to manage debt can improve your score anywhere from 5% to 20%.

Opportunity Cost (O)—Deep understanding of compounding (as in compound interest) and opportunity cost would result in a higher Money score and is also very likely to lead to better financial outcomes over the long run. Understanding compounding and opportunity cost really well can boost your Money score by 10% to 15%. In addition to the above major factors, the following minor factors can also impact your score by up to 3%-5% each:

Savings Rate (S)—How much money a person is able to save for retirement, investment, education, etc., has a large impact on your ability to accumulate wealth. And it also has some impact on a person's Money score. The savings rate in and of itself doesn't directly impact the Money score, but when taken in correlation with other attributes, it can make up to 5% difference in a person's score.

Age (Ag)—A person's age is a key score factor because financial risk appetite varies greatly with age. If you are exceptionally financially risk-averse at a very young age, then the Money score is lower. Conversely, if you take extreme financial risks at an older age, your score would also be lower. Age is only a correlating factor and does not impact the Money score directly.

Education & General Ability (E)—The highest level of education also correlates with information/knowledge and impacts a person's financial wellness portion of the Money score. General ability correlates to, and to some extent determines, knowledge and Alpha because the ability to hold a lot of unstructured information in your head and process it to arrive at decisions is more likely to result in Alpha.

Contrarian & Intellectual Agility (Ia)—If a person is comfortable being a contrarian, i.e., comfortable holding an unpopular opinion (and sticking to it) and swimming against the tide, that ability is reflected in the Money score. The Money score will be higher, and the person's financial wellness will likely be better as a result. Changing decisions when new information surfaces is a keystone habit of those with high Money scores.

Career & Income Growth (C)—Something can be created out of nothing. The first $100 k needs to be earned to be invested. And the most likely source of this first $100 k is a financially rewarding career. Therefore, 5-year growth in reported income (i.e., social security reported income which can be found on www.ssa.gov), especially the annual growth, captures the career growth over a period of years.

Investment Experience (Ie)—Years in the market determine the long-term financial outcomes. This is heavily influenced by the age at which a person starts investing.

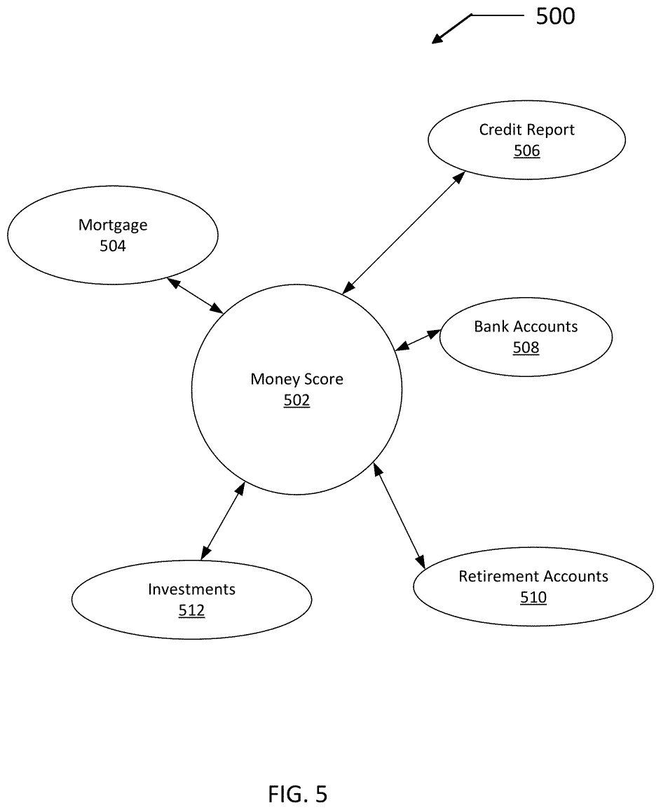

In FIG. 5, an illustration 500 of information used to generate a Money score 502 is depicted in accordance with an example implementation. The approach for generation of Money score 502 may access a person's financial accounts, such as mortgage account 504, credit report 506, bank accounts 508, retirement accounts 510 and investments 512 and electronic pull information directly from these accounts. This may be in addition to having a person answer multiple questions associated with the Money score factors. In the example implementation, a user would have to enter information associated with each of the different accounts, which may include login and passwords. The Money score approach may securely store (i.e., using encryption, such as public-private key encryption, basic encryption, or other type of known encryption) the login and password information for the other accounts and periodically access the accounts in order to update their Money score.

A personal financial repository, such as an electronic wallet, may be used as a storage location for the person's Money score. As the personal financial repository may also contain information for accessing of a person's other accounts (i.e., 504-512 of FIG. 5), the Money score generation and updating may be integrated with accessing the information in the personal financial repository automatically. In other implementations, permission may be requested by the Money score application prior to accessing account information in the personal financial repository. In yet other implementations, cryptocurrency and Non-fungible tokens accounts may also be accessed and used in the generation of the Money score. It is envisioned that more than one digital wallet may be maintained by a person and would be automatically accessed by the application to determine the Money score.

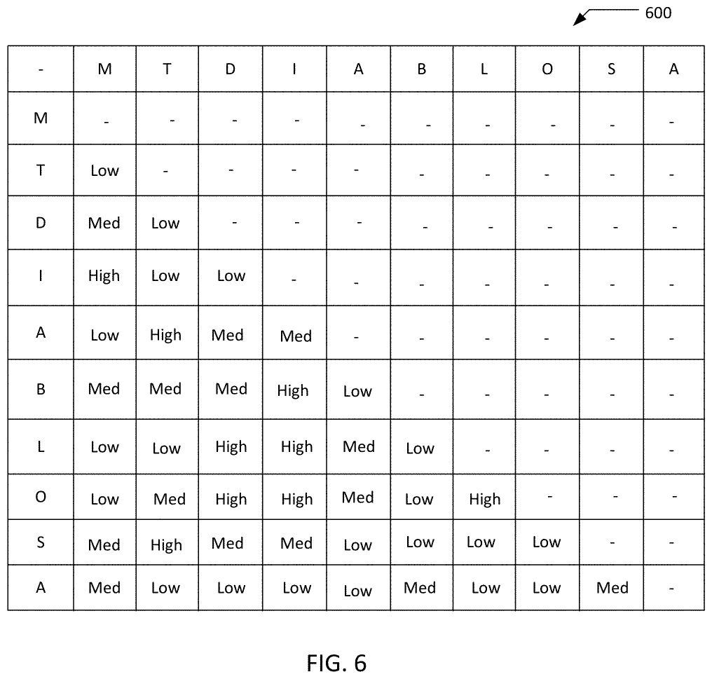

Turning to FIG. 6, a table 600 of the correlation of the Money score factors is depicted in accordance with an example implementation. The correlation assists in determining the Money score but also may be used to verify the validity of answers to the different questions. As responses to questions for different Money score factors with a high correlation in table 600 should also have a high correlation, similarly, for medium and low correlated Money score factors and questions.

The Money score may be updated by answering the weighted questions again and accessing the accounts identified in FIG. 5 in the current implementation. In other implementations, targeted questions may be accessed related to a portion of the Money score that is being updated and an updated Money score. Examples of targeted weighted questions would be associated with changes in a person's Opportunity Cost, Motivation, Temperament, Digitization, Information (knowledge), Alpha, Beta.

An example of the use of the Money score is when seeking financial advice from friends or relatives. Often bad and frivolous advice is offered with no way to calibrate how to measure the authenticity of the person doling out this advice. But by reviewing a person's Money score, an accurate indicator of financial wellness and performance of the advice-giving individual can be ascertained. When a person offers financial advice, they can be asked for a Money score access code (i.e., decryption key) for their Money score. The Money score server may be accessed by an agent (web application) where the Money score access code is entered, and that person's Money score is displayed. Other information, such as an identifier (person's name, picture, birth date, or other identification data) may be displayed. Thus, a Money score is securely stored but yet maybe selectively accessed for verification purposes.

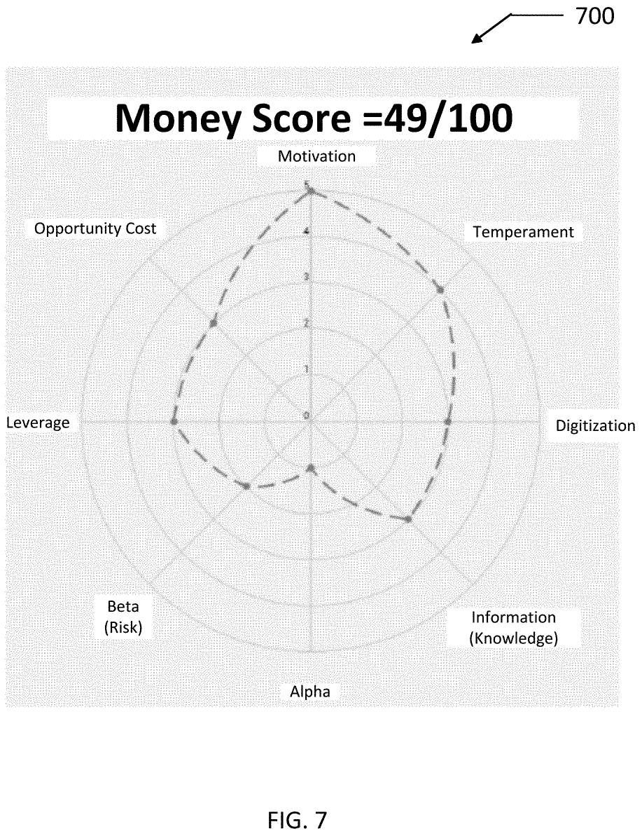

In FIG. 7, a spider plot 700 of the Money score factors that result in a Money score 502 of FIG. 5, in accordance with an example implementation of the invention. Each of the Money score factors in the example has been identified and weighted in accordance with their respective correlations. An example algorithm for determining an individual Money score is:

Step 1: Normalize each value so it is between 1 and 100.

Step 2: Money score=(0.05*(M+T+D+I+B))+0.15*A+0.20*L+O*0.10+(0.05*(S+Ag+E+Ia+C+Ie))

The individual Money score factors are added together and scaled to a value out of 100. In the current example, the resulting Money score is 49 out of 100. This Money score is a representation of a person's financial experience and/or knowledge, rather than a person's credit worthiness.

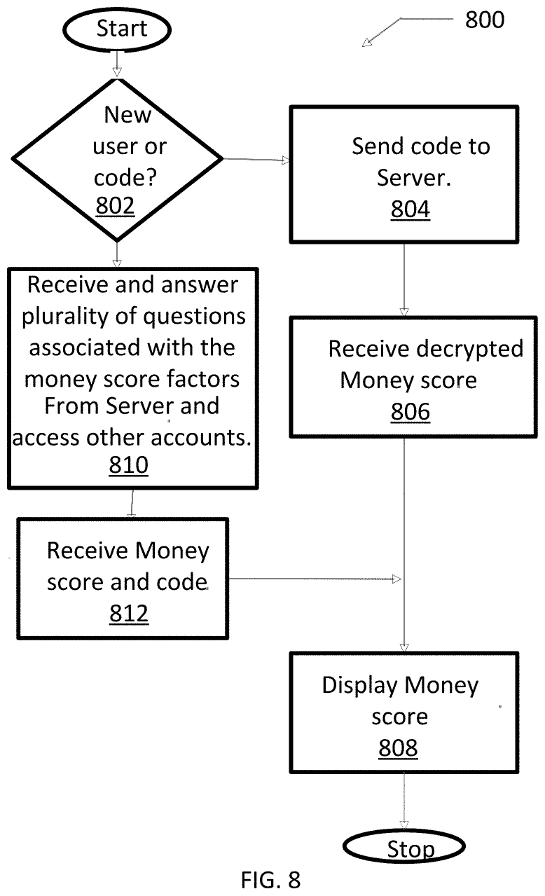

Turning to FIG. 8, a flow diagram 800 of a Money score approach of FIG. 4, is depicted in accordance with an example implementation. The high, medium, and low mathematical correlation of the Money score factors are identified. The MCD executes instructions that determine if a user is a new user/returning user or if the user of the MCD is seeking to access somebody else Money score in step 802. If it has been determined that a user of the MCD desires to access another person's Money score and has entered the code for that person (also in step 802), the MCD sends the code to the server for retrieval of the Money score associated with that code in step 804. The Money score that has been decrypted at the server is then sent to the MCD in step 806. In other implementations, the Money score may be sent encrypted to the MCD, where a public or local description key may be used to decrypt the Money score. The Money score is then displayed on the MCD in step 808. If the person using the MCD is a new user in step 802, then that person is prompted to enter the personal account information that is sent to the server to create a Money score user. A returning user is able to enter the code they have been assigned in step 802 to access their already derived Money score, as explained in steps 804-808. If the user is a new user who has set up an account or an existing user who seeks to update their Money score, they are provided a series of questions or prompts associated with the Money score factors, where the answers are sent to the server for processing in step 810. The server may also electronically access a person's other accounts, identified in FIG. 5, in determining the Money score. The resulting generated Money score is returned along with the code for accessing the Money score in step 812. The resulting Money score (and code) are displayed in step 808.

It will be understood and is appreciated by persons skilled in the art, that one or more processes, sub-processes, or process steps described in connection with FIG. 8 may be performed by hardware and/or software (machine-readable instructions). If the approach is performed by software, the software may reside in software memory in a suitable electronic processing component or system, such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable permanent media for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in a computer memory.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A computer-readable permanent media having instructions for creation of a Money score, comprising:
a first set of instructions for creating a money score user account;
a second set of instructions for providing a plurality of prompts associated with Money score factors;
a third set of instructions for receiving responses to the plurality of prompts;
a fourth set of instructions for applying predetermined weights to the plurality of responses; and
a fifth set of instructions for generating a generated Money score that is associated with the predetermined weights applied to the plurality of responses.

2. The computer-readable permanent media having instructions for creation of the Money score of claim 1, further includes a sixth set of instructions for encrypting the generated Money score.

3. The computer-readable permanent media having instructions for creation of the Money score of claim 2, wherein encrypting the Money score is a public-private key encryption of the generated Money score.

4. The computer-readable permanent media having instructions for creation of the Money score of claim 2, includes a seventh set of instructions for transmitting the generated Money score.

5. The computer-readable permanent media having instructions for creation of the Money score of claim 1, where the plurality of prompts are at least prompts for Alpha, Beta, Leverage, and Investment Experience.

6. The computer-readable permanent media having instructions for creation of the Money score of claim 1, includes a sixth set for saving the generated Money score in a memory.

7. The computer-readable permanent media having instructions for creation of a Money score of claim 1, wherein a sixth set of instructions stores the Money score in a digital wallet.

8. A method for creation of a Money score of a user, comprising:
receiving input identifying a plurality of and financial information from an user interface coupled to a processor;
identification of a plurality of financial accounts associated with the Money score by the processor;
retrieving data from the plurality of financial accounts; and
generating the Money score that is representative of financial experience of the user with the data from the plurality of financial accounts and personal financial information, where the Money score represents a user's financial knowledge.

9. The method for creation of the Money score of claim 8, further includes securing the Money score.

10. The method for creation of the Money score of claim 9, wherein securing includes storing the Money score in at least one digital wallet.

11. The method for creation of the Money score of claim 9, wherein securing includes encrypting the Money score.

12. The method for creation of the Money score of claim 11, wherein encrypting is public-private key encryption.

13. The method for creation of the Money score of claim 8, wherein generating the Money score includes weighting a plurality of Money score factors.

14. The method for creation of the Money score of claim 13, wherein the plurality of Money score factors include at least Alpha, Beta, Leverage, and Investment Experience.

15. The method for creation of the Money score of claim 8, further includes transmitting the Money score in response to a request from the user.
